(19) United States
(12) Patent Application Publication
(10) Pub. No.: US 2004/0173925 A1
(43) Pub. Date: Sep. 9, 2004

(54) Back pressure control method for an injection molding machine

(75) Inventor: Andreas Melkus, Oberndorf (AT)

Correspondence Address: HENRY M FEIEREISEN, LLC, 350 FIFTH AVENUE, SUITE 4714, NEW YORK, NY, 10118, US

(73) Assignee: MANNESMANN PLASTICS MACHINERY GMBH, Munchen (DE)

(21) Appl. No.: 10/755,710

(22) Filed: Jan. 12, 2004

Related U.S. Application Data
(63) Continuation of application No. PCT/EP02/07984, filed on Jul. 18, 2002.

(30) Foreign Application Priority Data
Jul. 20, 2001 (DE) 101 35 539.4

(51) Int. Cl. B29C 45/77

(52) U.S. Cl. 264/40.5; 264/328.1; 425/155; 425/145; 425/587

(57) ABSTRACT

The invention relates to a control method for controlling the back pressure in an injection molding machine which includes a first motor that axially displaces a screw and a second motor that turns the screw, whereby both motors act upon a common shaft. In order to control the back pressure, a speed value for controlling the second motor is furnished as a rotational speed input value to a control circuit for controlling the speed or rotation speed of the first motor. The back pressure is thus controlled in dependence on a pressure differential via the difference in rotation speeds of both motors.

### CROSS-REFERENCES TO RELATED APPLICATIONS

This application is a continuation of prior filed copending PCT International application no. PCT/EP02/07984, filed Jul. 18, 2002, which designated the United States and on which priority is claimed under 35 U.S.C. §120, the disclosure of which is hereby incorporated by reference.

This application claims the priority of German Patent Application, Serial No. 101 35 539.4, filed Jul. 20, 2001, pursuant to 35 U.S.C. 119(a)-(d), the disclosure of which is incorporated herein by reference.

### BACKGROUND OF THE INVENTION

The present invention relates to a control method for regulating the back pressure in an injection molding machine.

An injection molding machine of a type involved here is disclosed in U.S. Pat. No. 5,540,495 to Pickel, issued on Jul. 30, 1996, and includes an injection unit with a first motor for moving an extruder screw in axial direction, and a second motor for turning the extruder screw, whereby both motors are operatively connected to the screw through intervention of a common shaft.

European Pat. Publication No. EP 0 528 040 discloses a method of controlling a motor-driven injection molding machine in which the injection process as well as the back pressure control is realized by restricting the torque of the injection motor, i.e. the motor for moving the screw in axial direction. Also described is a screw position control by which the position of the screw is changed in dependence on a difference between a target back pressure and the actual back pressure.

It would be desirable and advantageous to provide an improved control method for controlling the back pressure in an injection molding machine, and more particularly a control method for use with an injection unit of the injection molding machine.

### SUMMARY OF THE INVENTION

According to one aspect of the present invention, a method of controlling the back pressure in an injection molding machine having a first motor, which rotates at a first rotation speed and moves a screw in an axial direction, and a second motor, which rotates at a second rotation speed and turns the screw, wherein the first and second motors act on a common shaft, includes the step of changing a difference between the first and second rotation speeds of the first and second motors for changing the back pressure.

According to an advantageous feature of the present invention, a value for the rotation speed of one of the motors representing, for example, the metering motor, is determined in a first control circuit. The so determined value is then transmitted as input value to a second control circuit for the other motor representing, for example, the injection motor. A difference between the rotation speeds of the two motors is then determined from a deviation between the target back pressure and the actual back pressure. The so determined difference between the rotation speeds is then added to the input value and used for controlling the injection motor.

According to the present invention, both motors (the metering motor and the injection motor) are initially controlled with same rotation speed, resulting in a back pressure of zero. The actual back pressure corresponding to the input value is realized by controlling the difference in the rotation speeds between the two motors. These additional control measures make the control system highly dynamic and accurate and optimize the control of the back pressure.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a longitudinal cross-section of a rear portion of an injection unit of an injection molding machine with a control system according to the present invention, and

FIG. 2 is a block diagram showing the relationship and operation of principal components of the control system.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

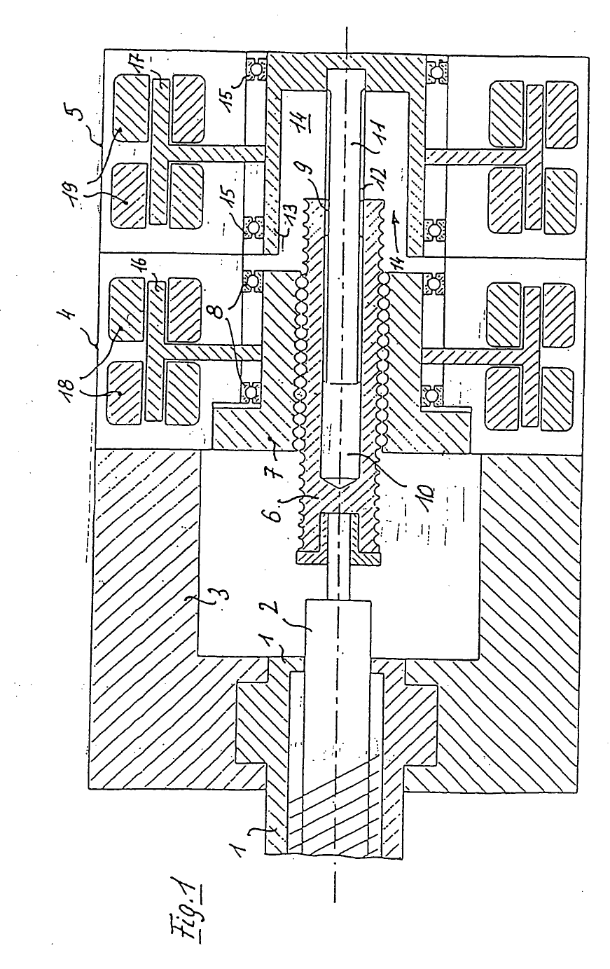

Turning now to the drawing, and in particular to FIG. 1, there is shown a longitudinal cross-section of a rear portion of an injection unit of an injection molding machine. For sake of simplicity, only those parts that are necessary for the understanding of the present invention will be described hereinafter. Other parts are shown and described, for example, in the aforementioned U.S. Pat. No. 5,540,495, the entire specification and drawings of which are expressly incorporated herein by reference. The injection unit includes an extrusion screw cylinder 1 and an extrusion screw 2 disposed in the screw cylinder 1. The extrusion screw cylinder 1 is received in a housing 3 on which a first hollow shaft motor 4 and a second hollow shaft motor 5 are mounted. The extrusion screw 2 is rigidly connected to a drive spindle 6 which is guided in a spindle nut 7, thereby establishing a ball bearing or circulating ball screw drive system. The spindle nut 7 constitutes the hollow shaft of the first hollow shaft motor 4 which is mounted directly in the motor housing 3 by means of a thrust bearing 8.

A drive pin 11 projects into a cavity 10 in the drive spindle 6. The cavity 10 is provided with axial ridges 9 which mate with axial grooves 12 of the drive pin 11, such that the drive spindle 6 turns with the drive pin 11 while being axially moveable thereon. The drive pin 11 is firmly connected with the hollow shaft 13 of the second hollow shaft motor 5, whereby the hollow shaft 13 surrounds the drive pin 11 leaving an annular space 14. The hollow shaft 13 is supported directly in the motor housing 3 by a thrust bearing 15.

Both the hollow shaft motors 4, 5 are constructed as transverse flux motors having cylindrical magnets 16, 17, wherein each of the magnets 16, 17 is surrounded on both sides by windings 18, 19, respectively.

In operation, the extrusion screw 2 carries out essentially two movements. During injection, the extrusion screw 2 is pushed forward and does not rotate. During plasticizing, the extrusion screw 2 rotates and is pushed axially backward by the plasticized material which is pressed into the extrusion screw end chamber (not shown). As a result, a definite resistance force (back pressure) is generated.

During injection, the first hollow shaft motor 4, which operates as the injection motor, turns the spindle nut 7, thereby displacing the extrusion screw 2 in an axial direction (to the left in FIG. 1). The second hollow shaft motor 5, which operates as the metering motor, does not rotate.

During plasticizing, the second hollow shaft motor 5 turns the extrusion screw 2 through the drive pin 11 with the required plasticizing torque. The hollow shaft first motor 4 should hereby turn with approximately the same rotation speed as the second hollow shaft motor 5. The difference in the rotation speeds represents the return travel speed of the extrusion screw 2.

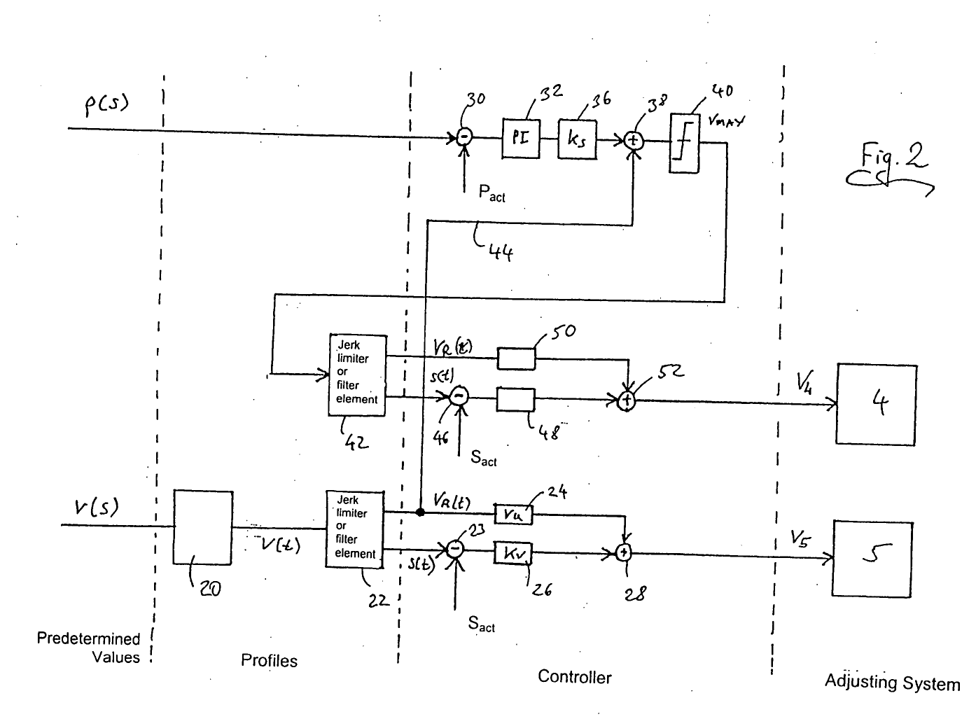

Turning now to FIG. 2, there is shown a block diagram showing the relationship and operation of principal components of a control system according to the present invention for incorporation in the injection molding machine of FIG. 1. The control system includes a first control circuit which receives predetermined speed values v(s) (or predetermined rotation speed values) that are converted in a profile element 20 into time-dependent speed data (or rotation speed data) v(t). These data are converted in a jerk limiter or filter element 22 into jerk-limited speed data v_{R}(t) (or rotation speed data) and speed-dependent position data s(t). The position data s(t) are supplied together with actual position data s_{act} to a subtracter 23, multiplied in a multiplier 26 by a constant value, and then added in an adder 28.

The time-dependent speed data (or rotation speed data) v(t) are also supplied to the adder 28, optionally after a multiplication in a multiplier 24. The output of adder 28 provides a speed or rotation speed signal V₅ for an inverter (not shown) that controls and/or powers the motor 5.

Position-dependent target pressure data p(s) are supplied to a second control circuit and applied to the input of a subtracter 30 where the actual pressure value Pact is subtracted from the target pressure data p(s). The difference determined in subtracter 30 is then processed by a proportional-integral (PI) circuit 24, multiplied by a constant value in multiplier 36 and supplied to an adder 38. The output of the adder 38 is supplied to a limiter 40 which limits the output signal from the adder 38 to a maximum permissible speed or rotation speed value vₘₐₓ. The output signal of the adder 38 is converted in a jerk limiter or filter element 42 into jerk-limited speed data v_{R}(t) (or rotation speed data) and speed-dependent position data s(t). The position data s(t) are supplied together with actual position data s_{act} to a subtracter 46, and following a multiplication with a constant in a multiplier 48, are supplied to an adder 52.

The time-dependent speed data (or rotation speed data) v(t) are also supplied to the adder 52, optionally after a multiplication in a multiplier 50. The adder 52 adds the output of the multiplier 48 and the output of the multiplier 50 and supplies a speed or rotation speed signal v₄ for operating an inverter (not shown) that controls and/or powers the motor 4.

In accordance with the present invention, the first and second control circuits are coupled together by a branch 44 which supplies the time-dependent speed (or rotation speed) signal of the first control circuit for the motor 5 as speed input value (or rotation speed input value) v(t) to the adder 38 of the second control circuit for the motor 4. Thus, the same input value for the rotation speed is initially supplied to both motors 4, 5, whereby the difference between the rotation speeds of the two motors 4, 5 required for a pressure input value is determined in the transfer elements 30, 32, 36 and added in adder 38 to the rotation speed input value.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method for controlling a back pressure in an injection molding machine having a first motor, which rotates at a first rotation speed for moving a screw in an axial direction, and a second motor, which rotates at a second rotation speed for rotating the screw, wherein the first and second motors act on a common shaft, said method comprising the step of changing a difference between the first and second rotation speeds for changing the back pressure.

2. The method of claim 1, wherein the first rotation speed is determined in a first control circuit and the second rotation speed is determined in a second control circuit, wherein a rotation speed value determined in the second control circuit is provided to the first control circuit as a rotation speed input value.

3. The method of claim 2, and further comprising the steps of determining in the first control circuit a difference between a target back pressure and an actual back pressure, determining a rotation speed difference based on the determined difference between the target back pressure and the actual back pressure, and adding to the determined rotation speed difference the rotation speed input value supplied by the second control circuit.

4. A method of controlling a back pressure in an injection molding machine, comprising the step of:
determining the rotation speed of a first motor intended for displacing a screw in an axial direction;
determining the rotation speed of a second motor intended for turning the screw;
determining a difference between the rotation speeds of the first and second motors, and
varying the difference between the rotation speeds for modifying the back pressure.

5. The method of claim 4, wherein the step of determining the rotation speed of the first motor is executed by a first control circuit which generates a rotation speed value, and the step of determining the rotation speed of the second motor is executed by a second control circuit which receives the rotation speed value from the first control circuit for use as rotation speed input value.

6. The method of claim 5, wherein the second control circuit executes the steps of determining a differential between a target back pressure and an actual back pressure, acquiring from the determined differential between the target back pressure and the actual back pressure the difference in the rotation speeds of the first and second motors; and adding the rotation speed input value from the first control circuit to the difference in the rotation speeds.

7. A control system for controlling a back pressure in an injection molding machine having a first motor, which rotates at a rotation speed for moving a screw in an axial direction, and a second motor, which rotates at a rotation speed for turning the screw, wherein the first and second motors act on a common shaft, said control system comprising:
a first control circuit for generating a time-dependent speed signal in response to the rotation speed of the first motor and; and
a second control circuit for generating a time-dependent speed signal in response to the rotation speed of the second motor, and
a connection line for coupling the first and second control circuits and supplying the time-dependent speed signal from the first control circuit to the second control circuit as a speed input value.

8. The control system of claim 7, wherein the second control circuit includes an adder which receives the time-dependent speed signal and adds a signal commensurate with a difference between a target back pressure and an actual back pressure.
